(19) United States
(12) Patent Application Publication
(10) Pub. No.: US 2011/0154255 A1
(43) Pub. Date: Jun. 23, 2011

(54) APPARATUS AND METHOD FOR SYNCHRONIZATION BETWEEN DEVICES THROUGH WIRELESS CONNECTION

(75) Inventors: Je-Hyok Ryu, Suwon-si (KR); Hun Lim, Yongin-si (KR); Jin-Wook Lee, Yongin-si (KR); Woo-Jin Park, Yongin-si (KR); Jin-Hyoung Kim, Hwaseong-si (KR); Shin-II Kang, Suwon-si (KR); Gene-Moo Lee, Seongnam-si (KR)

(73) Assignee: Samsung Electronics Co., Ltd., Suwon-si (KR)

(21) Appl. No.: 12/751,379

(22) Filed: Mar. 31, 2010

(30) Foreign Application Priority Data
Dec. 23, 2009 (KR) 10-2009-0130234
Mar. 31, 2010 (KR) 10-2009-0027439

(51) Int. Cl. G06F 17/30; G06F 15/16; G06F 3/048

(52) U.S. Cl. 715/810; 709/248; 707/634; 715/764; 707/E17.005

(57) ABSTRACT

An apparatus and method for synchronization between devices through a wireless connection are provided. The method includes sensing at least one event, selecting a policy corresponding to the at least one event from one or more preset policies, generating a transmission message including the event corresponding to the selected policy and transmitting to a counterpart device the transmission message, receiving from the counterpart device a reception message including the at least one event, confirming the policy corresponding to the event included in the reception message, and synchronizing a folder in real time by performing the event based on the policy.

### PRIORITY

This application claims priority under 35 U.S.C. §119(a) to Korean Patent Applications filed in the Korean Intellectual Property Office on Mar. 31, 2009 and Dec. 23, 2009 and assigned Serial Nos. 10-2009-0027439 and 10-2009-0130234, the entire disclosure of both of which is hereby incorporated by reference.

### BACKGROUND OF THE INVENTION

1. Field of the Invention

The present invention relates generally to folder synchronization between devices, and more particularly to an apparatus and method which are capable of performing work events of a user by carrying out specific folder synchronization between devices in real time.

2. Description of the Related Art

With the advancement of mobile communication terminal performance, it is possible to provide services that in the past were only provided by a personal computer (PC) as well as a simple communication functions such as a telephone or text message service. As many wireless network interfaces are mounted in a mobile communication terminal, communication between mobile communication terminals or between a PC and a mobile communication terminal can be achieved through a short-range network.

Generally, a short-range network refers to a communication network formed by interconnecting a plurality of short-range communication terminals. The short-range communication terminals may include communication terminals supporting a short-range network, such as PCs or mobile communication terminals. The short-range communication terminals may perform short-range communication with other short-range communication terminals using ZigBee™ (ZigBee), Bluetooth™ (Bluetooth), or Ultra-WideBand (UWB) communication. For example, the short-range communication terminals may perform short-range communication with each other according to a ZigBee communication scheme using ZigBee communication. The same principle is applied even when other communication schemes are used.

Various services may be provided based on the technology for communicating between short-range communication terminals using a contactless Wireless Personal Area Network (WPAN) scheme. A WPAN scheme enables a user to implement rapid and easy communication by interconnecting electronic devices. A communication solution of such a WPAN aims for data control between devices demanding complicated connectivity.

Thus, with the development of wireless access techniques such as a WPAN which can achieve short-range communication between devices, various services between short-range communication terminals may be provided. As an application of such services, it will be possible to transmit and share content between the terminals.

For example, a real-world method may be considered for transmitting or sharing content under the state that short-range communication terminals are located within a short range. The method will be described hereinbelow.

FIG. 1 is a block diagram illustrating a conventional scheme for communication between short-range communication terminals. It is assumed in FIG. 1 that the short-range communication terminals perform short-range communication using a Wi-Fi, ZigBee, Bluetooth, or Ultra-WideBand (UWB) communication scheme.

Referring to FIG. 1, in order to synchronize specific data, a first short-range communication terminal is connected with a second or third short-range communication terminal, thereby forming a communication-enabled state. The short-range communication terminals may be connected with each other using a Wi-Fi, ZigBee, Bluetooth, or UWB communication scheme and may include PCs, mobile communication terminals, smart phones, Personal Digital Assistants (PDAs), etc.

Typically, in order to share data between short-range communication terminals, the data is transmitted through an application required by each communication scheme or through an additional communication mode. A method for copying data as an example of sharing data is as follows. If a user selects data to be shared and transmits the data to a counterpart short-range communication terminal, a user of the counterpart short-range communication terminal determines whether to receive the data and stores the data. If the short-range communication terminal cannot use a required communication scheme or is in a poor environment, a user of the short-range communication terminal accesses a network and uploads the data. A user of the counterpart short-range communication terminal may then download the data, thereby sharing corresponding data.

However, since the above data sharing method shares data by transmitting and receiving the data according to user command or confirmation, it has the disadvantage that it is difficult to share the data in real time. A user must access a network whenever uploading or downloading data and must first search location information of data uploaded to a server upon downloading the data.

Accordingly, there exists a need for sharing data by synchronizing a file or folder in real time.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for synchronizing work events, such as bidirectional, real-time file sharing and file editing, without additional information log or history.

In accordance with one aspect of embodiments of the present invention, a method for synchronization between devices through a wireless connection includes sensing at least one event, selecting a policy corresponding to the at least one event from one or more preset policies, generating a transmission message including the event corresponding to the selected policy and transmitting the transmission message to a counterpart device, receiving a reception message including the at least one event from the counterpart device, confirming the policy corresponding to the event included in the reception message, and synchronizing a folder in real time by performing the event based on the policy.

In accordance with another aspect of embodiments of the present invention, an apparatus for synchronization between devices through a wireless connection includes a user interface for displaying and controlling one or more information elements when synchronization is performed, a synchronization manager for selecting a policy corresponding to the at least one event from one or more preset policies, generating a message including the at least one event corresponding to the selected policy, and transmitting the message to a counterpart device, a file manager for sensing the at least one event, receiving the message including the at least one event from the counterpart device, confirming the policy corresponding to the event included in the received message, and performing the at least one event based on the selected policy, and a folder including at least one file to be synchronized with the counterpart device.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram illustrating a conventional scheme for communication between short-range communication terminals;

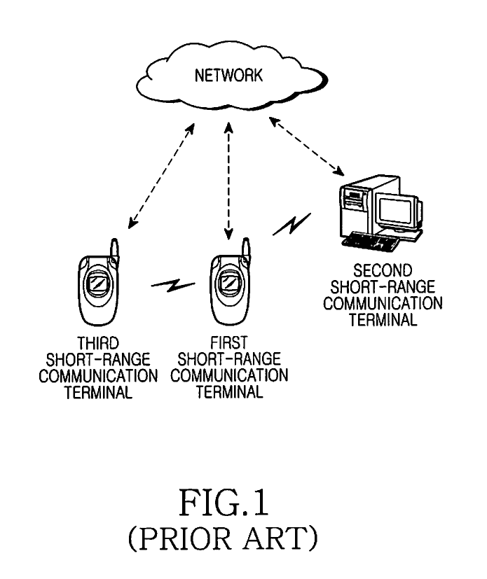

FIG. 2 is a block diagram of a system for performing folder synchronization between devices according to an embodiment of the present invention;

FIG. 3 is a flow chart illustrating a process for performing folder synchronization between devices according to an embodiment of the present invention;

FIG. 4 is a flow chart illustrating a process for performing first synchronization between two devices according to an embodiment of the present invention;

FIG. 5 is a flow chart illustrating a process for generating and updating a file between two devices according to an embodiment of the present invention;

FIG. 6 is a flow chart illustrating a process for deleting and renaming a file between two devices according to an embodiment of the present invention; and

FIG. 7 is a diagram illustrating synchronization implementation between two devices according to an embodiment of the present invention.

Throughout the drawings, the same drawing reference numerals will be understood to refer to the same elements, features and structures.

### DETAILED DESCRIPTION OF EMBODIMENTS OF THE INVENTION

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

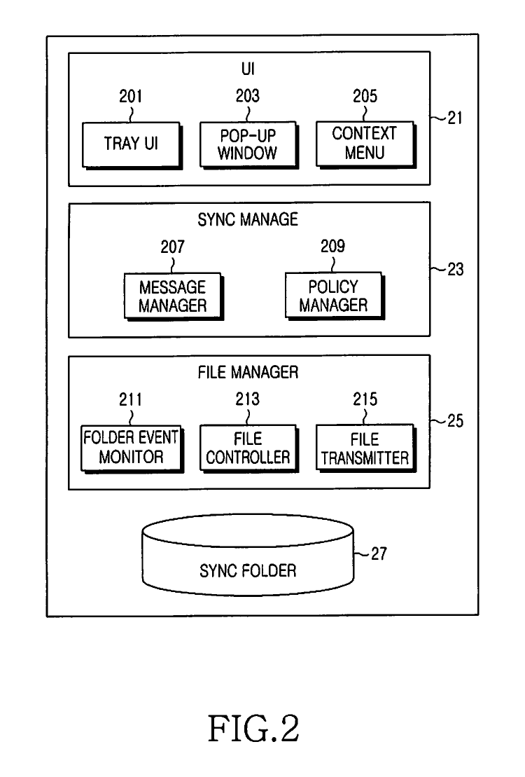

FIG. 2 is a block diagram of a system for performing folder synchronization between devices according to an embodiment of the present invention. The system for performing folder synchronization includes a User Interface (UI) 21, a synchronization manager 23, a file manager 25, and a synchronization folder 27. The UI 21 includes a tray UI 201, a pop-up window 203, and a context menu 205. The synchronization manager 23 includes a message manager 207 and a policy manager 209. The file manager 25 includes a folder event monitor 211, a file controller 213, and a file transmitter 215.

Referring to FIG. 2, the UI 21 informs a user of the access, file processing, and connection state of the synchronization folder 27 in which a file to be synchronized is included. Namely, the UI 21 serves to display and control information necessary when a user employs a folder synchronization function. In more detail, the UI 21 performs synchronization of a desired file using the context menu 205. In a PC for example, the context menu 205 may be included in a menu of a right button of a mouse or may be implemented by pressing a specific key. The UI 201 uses the tray UI 201 to confirm time information about when the last synchronization was performed, information about a device in which synchronization is to be performed, information about whether a device in which synchronization is to be performed accesses a network, a synchronization progress rate, information about a change of a folder, and the like, and uses the pop-up window 203 to confirm progress indication of a current state. The UI 21 may be differently constructed according to characteristics of a device.

The synchronization manager 23 determines whether to perform synchronization based on file events within the synchronization folder 27 obtained from the file manager 25. Moreover, the synchronization manager 23 functions to manage policies for applying related messages and synchronization events. Namely, the synchronization manager 23 monitors events such as the generation, deletion, and update of files or directories.

In more detail, the message manager 207 manages messages for related events between devices so that the messages may be transmitted and received in real time. The policy manager 209 applies a suitable policy according to the circumstance of a generated event. The synchronization manager 23 includes one or more predefined synchronization policies. The policy manager 209 selects a suitable policy from the synchronization policies included in the synchronization manager 23. The synchronization policies may include the following policies.

Synchronization Policies

1. During connection: if a wireless connection between a PC and a mobile terminal is completed, first synchronization for a designated synchronization folder is performed once. When a new file is present in a folder, a policy for filing the new file by automatically copying the new file into a folder having no new folder is carried out.

2. Generation: if a new file is present in only one of two folders as a result of comparing file lists within the folders, the new file is copied to a folder having no new file. Even when a user generates a specific file, the generated file is copied to a synchronized folder.

3. Deletion: if a file is deleted from a designated folder in a wirelessly connected state, a policy for deleting a file of another synchronized folder is implemented. This policy has priority over a policy for filing a file and is applied only when two devices are being connected.

4. Update: if files having the same name are present in respective folders as a result of comparing file lists within the folders, one file is updated by another file modified on a more recent date.

In addition to the above basic bidirectional real-time synchronization policies, only a file type designated by a user may be synchronized, unidirectional synchronization may be performed by dividing two devices into a master and a slave, or synchronization may be performed only at the request of a user.

The synchronization manager 23 determines whether an event exchange between devices is needed based on the above policies and if necessary the synchronization manager 23 transmits files or directories. The synchronization manager 23 may apply a limited synchronization function for performing synchronization only for files of a type desired by a user.

The file manager 25 monitors whether one or more synchronization events occur. If one or more synchronization events occur, the file manager 25 accesses a corresponding file to be synchronized and processes the events. That is, the file manager 25 processes a command such as the generation, deletion, or update of any file or directory contained within the synchronization folder 27. To easily process events, the file manager 25 may provide operating system independent compatibility.

In more detail, the folder event monitor 211 serves to monitor one or more file related events, such as the generation and deletion of a file generated in the synchronization folder 27 and a change of a file name. If the file related events are monitored, the folder event monitor 211 informs the file controller 213 of the occurrence of the events. The file controller 213 then controls the folder event monitor 211 so as to transmit the fact that the related events have occurred to the synchronization manager 23. The file transmitter 215 transmits a specific file within the synchronization folder 27 to a wirelessly connected counterpart device according to the determination of the synchronization manager 23 or receives files from the counterpart device to update the files in the synchronization folder 27.

The synchronization folder 27 refers to a space in which one or more files to which a synchronization event between devices is actually applied are located. The synchronization folder 27 where synchronization is to be performed includes files to be copied, edited, or deleted. A user may directly designate or change the synchronization folder 27. At first, a user may generate any empty folder which is preset and may set the empty folder as the synchronization folder 27. Although not shown in FIG. 2, one or more files or directories may be shared in addition to or instead of the synchronization folder 27. Directories refer to information such as address lists or telephone numbers.

While FIG. 2 illustrates a system configuration based on a PC as an example, the system configuration may differ according to device type. A mobile terminal for example may selectively include the pop-up window 203 depending on whether the terminal supports a device platform and may add a function such as a synchronization search application instead of the context menu 205. Meanwhile, a smart phone or a PDA with an operating system similar to a PC may achieve the same system configuration as the PC.

A process for performing folder synchronization between devices using the system configuration of FIG. 2 according to events will now be described.

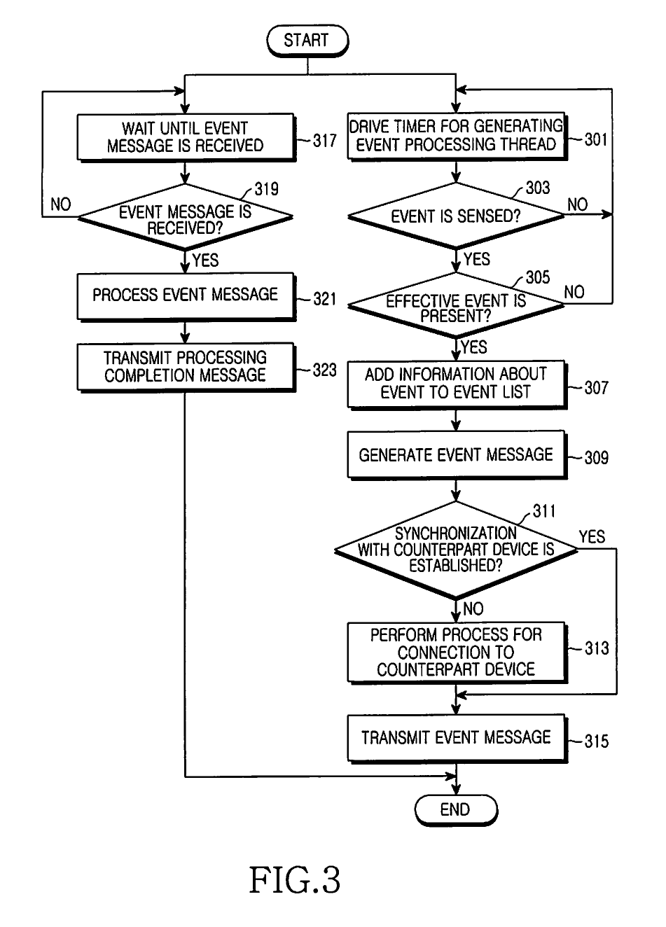

FIG. 3 is a flow chart illustrating a process for performing folder synchronization between devices according to an embodiment of the present invention. Since the present invention describes a bidirectional structure, an event transmission process and an event reception process are shown in FIG. 3.

In the event transmission process, a device drives a timer for generating an event processing thread in step 301. This procedure is started irrespective of whether or not an event is sensed. The device determines in step 303 whether an event is received from a user. If no event is sensed, step 303 returns to step 301. If an event is sensed in step 303, the device determines whether an effective event is present in step 305. If no effective event is present, step 305 returns to step 301. If an effective event is sensed in step 305, the device adds information about the sensed event to an event list in step 307.

In step 309, the device generates an event message to be transmitted to a counterpart device using the information about the sensed event. The device determines whether synchronization with the counterpart device is established in step 311. If synchronization is established, the device transmits the event message to the counterpart device in step 315, and if not, the device performs a process for connection to the counterpart device in step 313. Step 313 is then followed by step 315 to transmit the event message to the counterpart device.

In the event reception process, the device waits until an event message is received from the counterpart device in step 317. The device determines whether the event message is received in step 319. If the event message is not received, step 319 returns to step 317. If the event message is received, the device confirms policies and information included in the received message and processes the received message according to the policies and information included therein in step 321. The device transmits a processing completion message to the counterpart device in step 323.

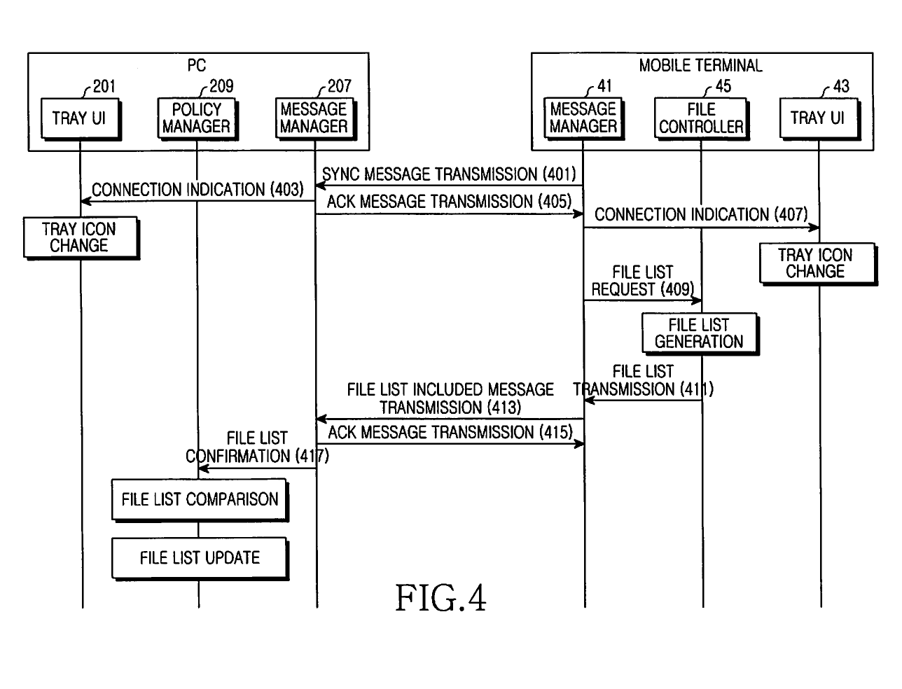

FIG. 4 is a flow chart illustrating a process for performing first synchronization between two devices according to an embodiment of the present invention.

Referring to FIG. 4, a mobile terminal transmits to a massage manager 207 of a PC a synchronization message through a message manager 41 thereof in step 401. The message manager 207 of the PC then informs a user of a fact that synchronization has been performed in step 403. To inform a user of the fact, the tray UI 201 changes a tray icon so as to easily confirm the fact through a visual indication. The message manager 207 transmits to the message manager 41 of the mobile terminal an acknowledgement message for the synchronization message in step 405. The message manager 41 of the mobile terminal receiving the acknowledgement message informs a user of a fact that synchronization has been performed in step 407. To inform a user of the fact, the tray UI 43 changes a tray icon so as to easily confirm the fact through a visual indication. If connection is made as described above, first synchronization is ready after connecting designated folders or basic folders when there is no designated folder and a next procedure is performed.

The message manager 41 of the mobile terminal requests a file controller 45 to transmit a file list within a shared folder in step 409. The file controller 45 then generates the file list and transmits to the message manager 41 the file list in step 411. The message manager 41 transmits to the message manager 207 of the PC the received file list in step 413. The message manager 207 transmits to the message manager 41 of the mobile terminal an acknowledgement message for the file list in step 415. The message manager 207 of the PC transmits to a policy manager 209 the received file list in step 417. The policy manager 209 compares the received file list with its file list and updates its file list by applying a comparison result to a suitable policy. For example, if a new file is present in the received file list or if the contents of files having the same name differ, the policy manger 209 generates or updates a file list and then receives a generated or updated file from the mobile terminal to adjust synchronization of the shared folder.

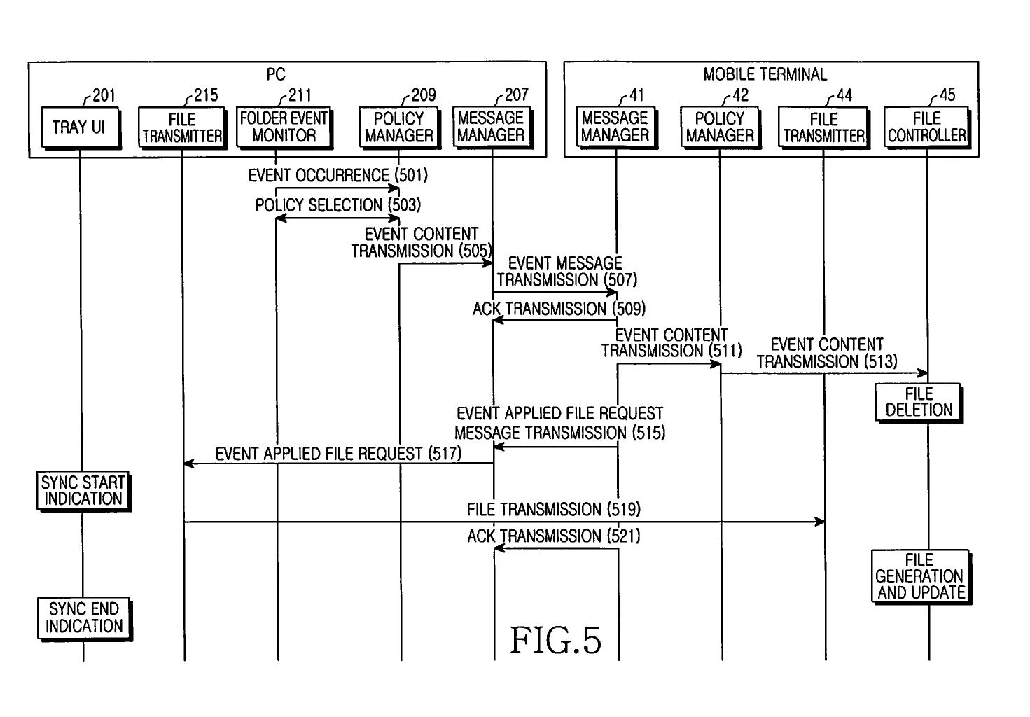

FIG. 5 is a flow chart illustrating a process for generating and updating a file between two devices according to an embodiment of the present invention.

Referring to FIG. 5, if an event such as the generation or update of a specific file in a synchronization folder is monitored, a folder event monitor 211 of a PC informs a policy manager 209 that an event has occurred in step 501. The policy manager 209 selects a corresponding policy by analyzing a type of the generated event in step 503. It is assumed that the generation or update of a specific file is considered as the occurrence of an event. The policy manager 209 transmits to a message manager 207 the contents of a corresponding event in step 505. The message manager 207 transmits to a message manager 41 of a mobile terminal an event message including generation or update information of a specific file in step 507. The message manager 41 of the mobile terminal transmits an acknowledgement message for the event message to the message manager 207 of the PC in step 509.

The message manager 41 transmits information included in the event message to a policy manager 42 in step 511. The policy manager 42 confirms a type of the information included in the message and selects a suitable policy. In step 513, if the information included in the event message indicates information about the generation of a file, the policy manager 42 generates a generation message and transmits to a file controller 45 the message, and if the information included in the event message indicates information about the update of a file, the policy manager 42 transmits to the file controller 45 a message indicating that an existing file stored in a synchronization folder of the mobile terminal should be deleted.

If the existing file has been deleted, the message manager 41 transmits to the message manager 207 of the PC a request message for a generated or updated file in step 515. The message manager 207 then requests the file transmitter 215 to transmit the generated or update file in step 517. The file transmitter 215 is connected to the file transmitter 44 of the mobile terminal and transmits to the file transmitter 44 of the mobile terminal the generated or updated file in step 519. The file transmitter 44 of the mobile terminal stores the generated or updated file in the synchronization folder of the mobile terminal by the control of the file controller 45. The message manager 41 of the mobile terminal transmits to the message manager 207 of the PC an acknowledgement message indicating that a specific file has been received in step 521.

While the above processes are performed, the tray UI 201 of the PC may display a synchronization start or end indication when the transmission of the generated or updated file is started or ended so that a user may confirm a synchronization start or end time point. As described above, FIG. 5 illustrates an example for processing an event from the PC to the mobile terminal. However, even when the same event is processed from the mobile terminal to the PC, the same principle is applied for bidirectional, real-time synchronization of a folder.

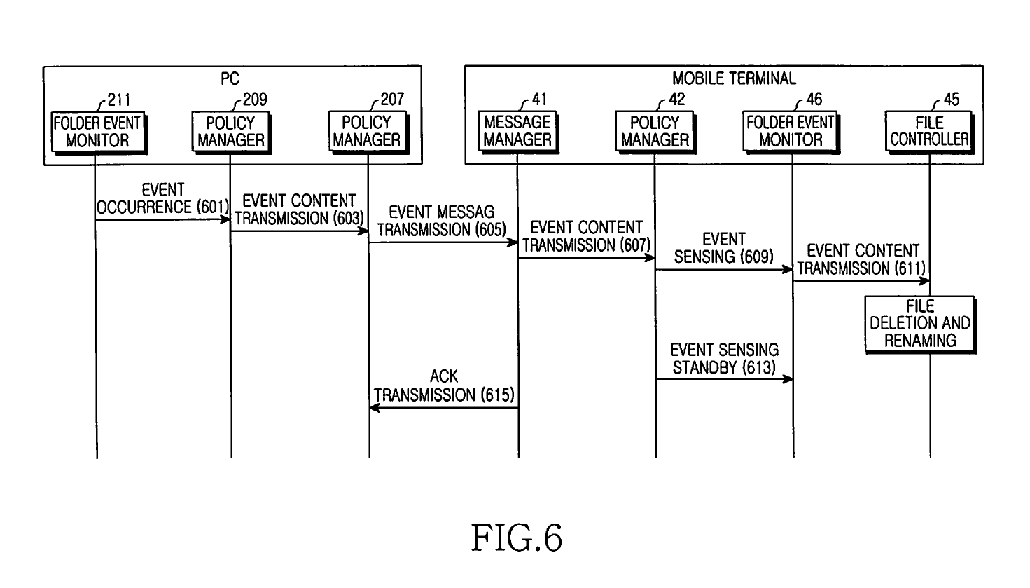

FIG. 6 is a flow chart illustrating a process for deleting and renaming a file between two devices according to an embodiment of the present invention.

Referring to FIG. 6, if an event such as the deletion of a specific file in a synchronization folder occurs, a folder event monitor 211 of a PC informs a policy manager 209 that an event has occurred in step 601. The policy manager 209 analyzes a type of the event to select a corresponding policy and transmits to a message manager 207 the contents of the event in step 603. It is assumed in FIG. 6 that a deletion event of a specific file has occurred. The deletion event may occur while two devices are connected to each other. The message manager 207 transmits to a message manager 41 of a mobile terminal an event message including deletion information of a specific file which is a counterpart device in step 605.

The message manager 41 of the mobile terminal transmits to a policy manager 42 information included in the received event message in step 607. The policy manager 42 analyzes a type of the event to select a corresponding policy and transmits to a folder event monitor 46 the policy in step 609. The folder event monitor 46 confirms the reception of the event and transmits to a file controller 45 a deletion message for a specific file in step 611. The file controller 45 deletes a specific file in a shared folder upon receiving the deletion message for the specific file. The folder event monitor 46 enters a standby state to sense another event in step 613. If another event occurs, the folder event monitor 46 performs an operation corresponding to the other event. If the specific file has been deleted, the message manager 41 of the mobile terminal transmits to the message manager 207 of the PC an acknowledgement message indicating that the specific file has been deleted in step 615.

While, in FIGS. 4, 5, and 6, processes for performing synchronization between the PC and the mobile terminal and synchronizing the synchronization folder have been described, the above processes may be applied even when bidirectional synchronization between PCs or between mobile terminals is performed.

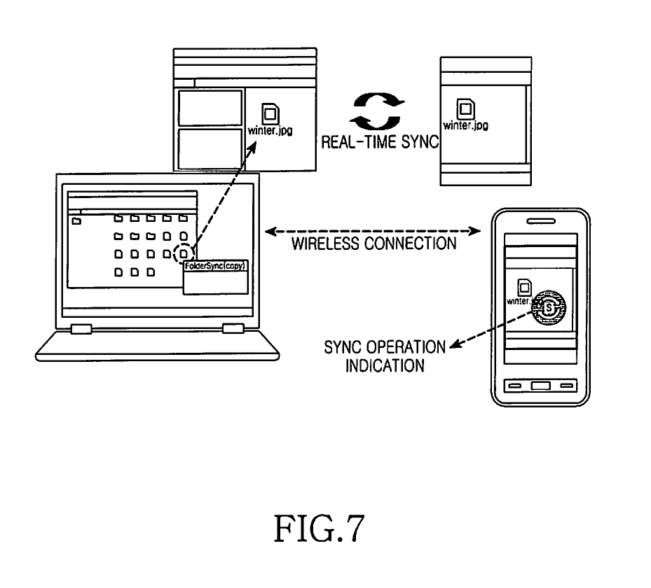

FIG. 7 is an diagram illustrating synchronization implementation between two devices according to an embodiment of the present invention. As illustrated in FIG. 7, a PC may add a ‘folder synchronization’ function to a right button menu of a mouse so that the PC may perform synchronization with another device through a synchronization folder designating a file of another folder. If the PC generates or updates a text file ‘winter’ in its synchronization folder, the text file ‘winter’ is automatically generated in a synchronization folder of another device, for example, a mobile terminal or updated when the text file ‘winter’ is already present in the synchronization folder of the mobile terminal. The deletion of a file is implemented while synchronization between two devices is performed. If the text file ‘winter’ is deleted from the PC, the text file ‘winter’ in the synchronization folder of the mobile terminal is also deleted. When no text file named ‘winter’ is present in the synchronization folder of the mobile terminal, an event does not occur.

Although FIG. 7 illustrates a process for copying or generating a specific file from a PC to a mobile terminal, it is possible to perform bidirectional, real-time synchronization to copy or generate a specific file from the mobile terminal to the PC.

As is apparent from the above description, the present invention can rapidly share work by wirelessly performing synchronization between devices in real time, and can rapidly manage files of a folder synchronized between devices and can increase mobility by providing a bidirectional work event in real time.

Although the embodiments of the present invention have been disclosed for illustrative purposes, various modifications, additions and substitutions are possible, without departing from the scope and spirit of the invention as disclosed in the accompanying claims. Accordingly, the scope of the present invention should not be limited to the description of the embodiment, but defined by the accompanying claims and equivalents thereof.

What is claimed is:

1. A method for synchronizing devices through a wireless connection, comprising the steps of
sensing at least one event;
selecting a policy corresponding to the at least one event from one or more preset policies;
generating a transmission message including the event corresponding to the selected policy and transmitting to a counterpart device the transmission message;
receiving from the counterpart device a reception message including the at least one event;
confirming the policy corresponding to the event included in the reception message; and
synchronizing a folder in real time by performing the event based on the policy.

2. The method of claim 1, wherein the one or more preset policies include policies for generation, update, and deletion of at least one file included in the folder.

3. The method of claim 2, wherein the policy for the generation or update is a policy for generating or updating a file in a synchronized counterpart device folder when the file included in the folder is generated or updated.

4. The method of claim 3, wherein the policy for the update is a policy for deleting an existing file stored in the counterpart device folder and copying the updated file to the counterpart device folder, when the same file is present in the counterpart device folder.

5. The method of claim 4, wherein the policy for the update is a policy for comparing modification dates of files having the same name and overwriting an older file with a more recent file based on the comparison result.

6. The method of claim 2, wherein the policy for the deletion is a policy for deleting the same file stored in the counterpart device folder when a specific file in the folder is deleted.

7. The method of claim 6, wherein the policy for the deletion is applied only during connection to the counterpart device.

8. The method of claim 1, wherein synchronization is limited to only a specific type of file among files included in the folder.

9. The method of claim 1, wherein if the folder does not exist, an empty folder is generated.

10. The method of claim 1, wherein bidirectional synchronization of a file is performed without an additional information log or history for synchronization when the devices are connected to each other.

11. An apparatus for synchronizing devices through a wireless connection, comprising:
a user interface for displaying and controlling one or more information elements when synchronization is performed;
a synchronization manager for selecting a policy corresponding to the at least one event from one or more preset policies, generating a message including the at least one event corresponding to the selected policy, and transmitting to a counterpart device the message;
a file manager for sensing the at least one event, receiving from the counterpart device the message including the at least one event, confirming the policy corresponding to the event included in the received message, and performing the at least one event based on the selected policy; and
a folder including at least one file to be synchronized with the counterpart device.

12. The apparatus of claim 11, wherein the user interface includes:
a tray user interface for confirming information about time when synchronization with the counterpart device was last performed, information about a device with which synchronization is to be performed, information indicating whether the device with which synchronization is to be performed is connected to a network, a synchronization progress rate, and information about a change of a folder; and
a context menu for performing synchronization of the at least one file.

13. The apparatus of claim 11, wherein the synchronization manager includes:
a policy manager for selecting a policy corresponding to at least one event from one or more preset policies; and
a message manager for generating a message including the at least one event corresponding to a preset policy and transmitting the generated message to the counterpart device.

14. The apparatus of claim 13, wherein the policy manager performs policies for generation, update, and deletion of at least one file included in the folder.

15. The apparatus of claim 14, wherein the policy for the deletion deletes the same file stored in a counterpart device folder and is applied only during connection to the counterpart device, when a specific file in the folder is deleted.

16. The apparatus of claim 14, wherein the policy for the update is a policy for deleting an existing file stored in the counterpart device folder and copying the updated file to the counterpart device folder, when the same file is present in the counterpart device folder.

17. The apparatus of claim 11, wherein the file manager includes:
a folder event monitor for sensing the at least one event;
a file controller for controlling the folder event monitor to transmit to the synchronization manager that the at least one event has occurred; and
a file transmitter for transmitting and receiving at least one file included in the folder.

18. The apparatus of claim 11, wherein only a file of a specific type is synchronized among files included in the folder.

19. The apparatus of claim 11, wherein bidirectional synchronization of a file is performed without an additional information log or history for synchronization when the devices are connected to each other.
